(19) United States
(12) Patent Application Publication
(10) Pub. No.: US 2015/0163584 A1
(43) Pub. Date: Jun. 11, 2015

(54) AUDIO DEVICE FOR HEADPHONE

(71) Applicant: MERRY ELECTRONICS (SHENZHEN) CO., LTD., SHENZHEN (CN)

(72) Inventor: Chung-Yi HUANG, Taichung City (TW)

(73) Assignee: MERRY ELECTRONICS (SHENZHEN) CO., LTD., SHENZHEN (CN)

(21) Appl. No.: 14/099,022

(22) Filed: Dec. 6, 2013

(51) Int. Cl. H04R 1/10

(52) U.S. Cl. CPC H04R 1/1091

(57) ABSTRACT

An audio device for a headphone is formed of a main body and an audio unit. The main body is annular and includes a lateral side facing and surrounding its center to define an audio cavity. The main body includes an accommodation space internally and at least one sound outlet communicating with the accommodation space and the sound outlet. The audio device is mounted inside the accommodation space. In light of this structure, the audio device looks lightweight visually and is breathable to make the user feel comfortable while wearing the headphone.

### BACKGROUND OF THE INVENTION

1. Field of the Invention

The present invention relates generally to an audio device for a headphone and more particularly, to an audio device that is annular externally and hollow internally to be visually lightweight and preferably breathable.

2. Description of the Related Art

A conventional headphone is formed of a C-shaped connector and two audio devices mounted to two ends of the C-shaped connector separately and can be worn on a user's head for playing sound. The audio devices are designed to be solid internally for covering the user's ears to make the speakers installed inside the audio devices directly output the sound to the user's ears, so the headphone is heavy as a whole. Besides, the conventional headphone can additionally include respective earmuffs mounted to the audio devices for the purpose of physically reducing noise, so the headphone becomes larger to look clumsy and adversely affect the breathability to further make the user feel uncomfortable while wearing the headphone.

### SUMMARY OF THE INVENTION

The primary objective of the present invention is to provide an audio device that can make a headphone having the audio device visually lightweight.

The secondary objective of the present invention is to provide an audio device that is preferably breathable to make the user feel comfortable while wearing a headphone having the audio device.

The foregoing objectives of the present invention are attained by the audio device formed of a main body and an audio unit. The main body is annular and includes a lateral side facing and surrounding its center to define an audio cavity. The main body includes an accommodation space internally and at least one sound outlet formed on the lateral side and communicating with the accommodation space and the sound outlet. The audio device is mounted inside the accommodation space.

Preferably, the audio unit includes at least one speaker.

Preferably, the sound outlet is annular in shape or including a purity of holes to install on the lateral side in a predetermined interval.

Preferably, the audio device further includes a transparent cover sealing one side of the audio cavity for enhanced audio resonance.

### BRIEF DESCRIPTION OF THE DRAWINGS

FIG. 1 is a side view of a preferred embodiment of the present invention, illustrating that the audio unit is an annular speaker.

FIG. 2 is a cross-sectional view taken along a line 2-2 indicated in FIG. 1, illustrating the position of the sound outlet.

FIG. 3 is another side view of the preferred embodiment of the present invention, illustrating that the audio unit is mounted to the main body and adjacent to the connector.

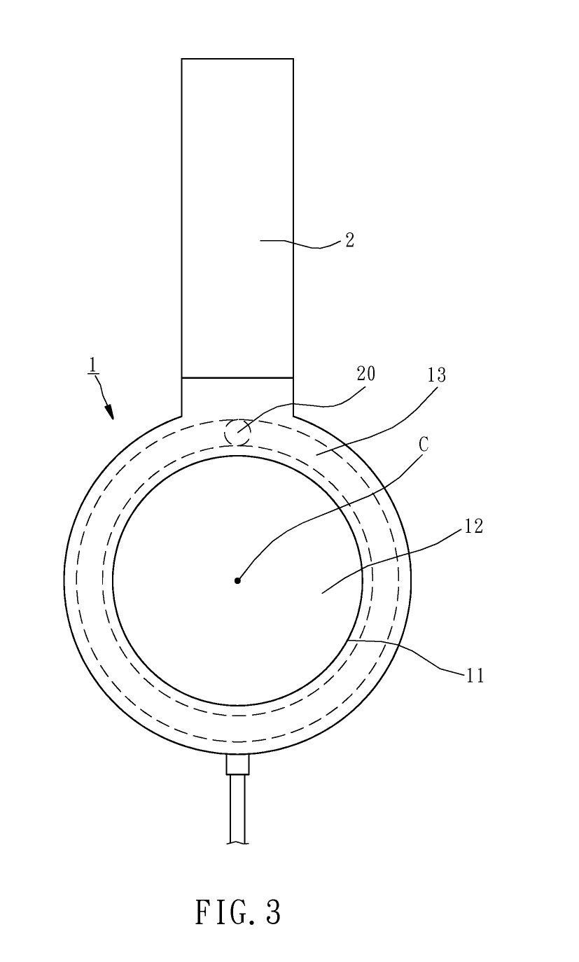

FIG. 4 is another side view of the preferred embodiment of the present invention, illustrating that a plurality of the speakers are arranged in a predetermined interval.

FIG. 5 is another cross-sectional view of the preferred embodiment of the present invention, illustrating that a plurality of sound outlets are arranged on the lateral side in a predetermined interval.

FIG. 6 is another cross-sectional view of the preferred embodiment of the present invention, illustrating that the sound outlet is located at the second shell.

FIG. 7 is another cross-sectional view of the preferred embodiment of the present invention, illustrating that the transparent cover is additionally included.

### DETAILED DESCRIPTION OF PREFERRED EMBODIMENTS

Structural features and desired effects of the present invention will become more fully understood by reference to a preferred embodiment given hereunder. However, it is to be understood that the embodiment is given by way of illustration only, thus is not limitative of the claim scope of the present invention.

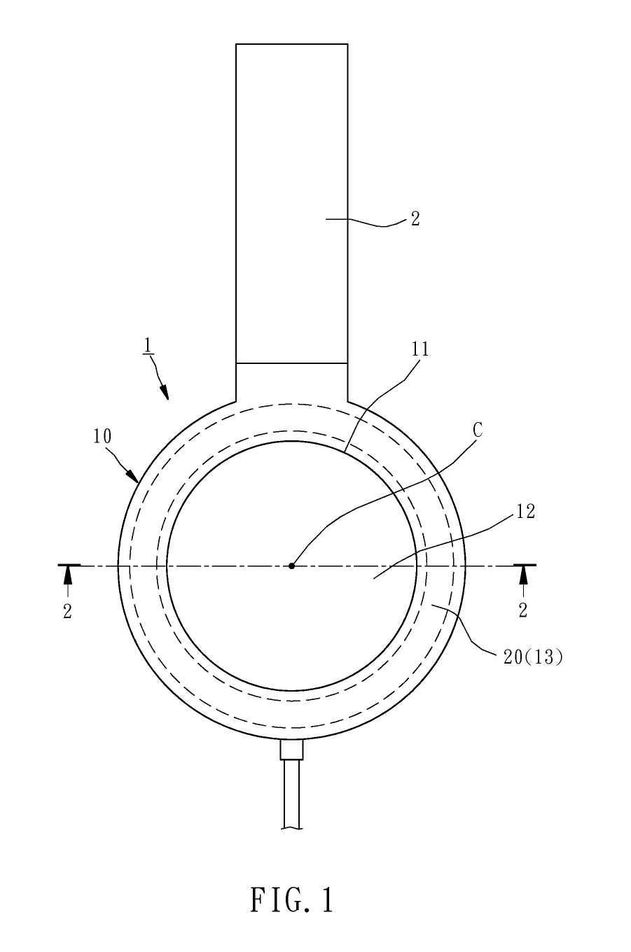

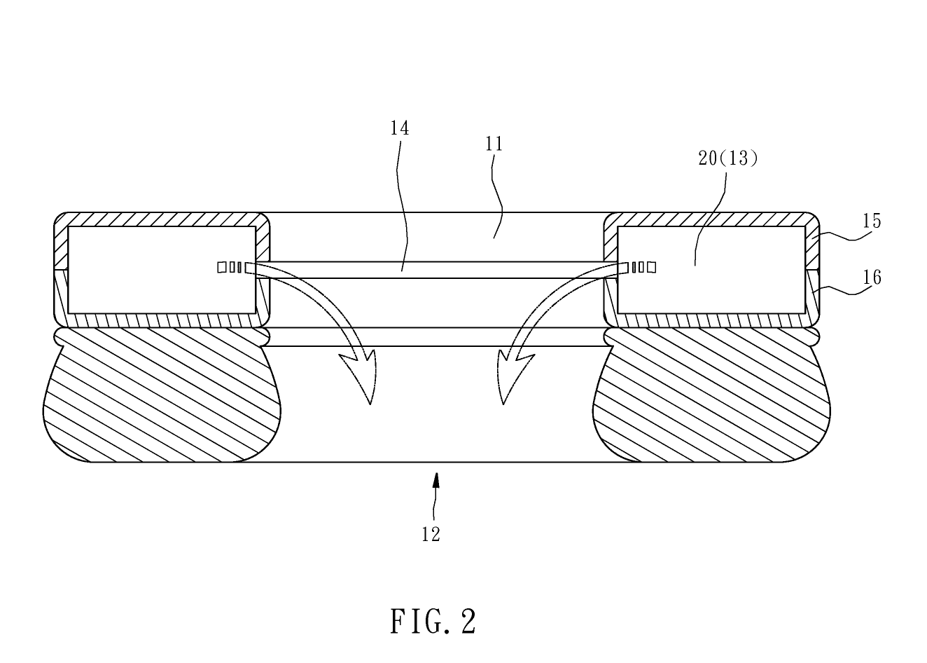

Referring to FIGS. 1 and 2, an audio device 1 constructed according to a preferred embodiment of the present invention is applied to a headphone worn by a user on his or her head via a C-shaped connector 2. The audio device 1 is formed of a main body 10 and an audio unit 20 mounted inside the main body 10. The detailed descriptions and operations of these elements as well as their interrelations are recited in the respective paragraphs as follows.

Referring to FIG. 1 again, the main body 10 is annular and includes a lateral side 11 facing and surrounding its center C to form an audio cavity 12 for acoustic resonance to further emit the sound to the user's ears. Referring to FIG. 2, the main body 10 is formed of a first shell 15 locate in an outer side away from the user's ear, and a second shell 16 butt in joint with the first shell 15. Thus, the main body 10 includes an accommodation space 13 formed internally. A gap is formed between the first and second shells 15 and 16 to define an elongated annular sound outlet 14 located at the lateral side 11 and communicating with the accommodation space 13 and the audio cavity 12.

The audio unit 20 is an annular speaker and mounted inside the accommodation space 13 for generating sound signal. The outputted sound signal can be delivered to the audio cavity 12 through the sound outlet 14 and then to the user's ears. Please refer to the arrows indicated in FIG. 2 for the direction of the sound output.

The main body 10 is annular in shape and includes a midsection falling within the audio cavity 12, so the main body 10 is visually hollow to look lightweight relatively as compared with the audio device of the conventional headphone. In addition, when the user wears the headphone having the audio device 1 of the present invention, the audio cavity 12 faces the user's ears and contacts the external air, so the audio device 1 has preferable breathability to make the user feel comfortable.

It is to be noted that the technician in this field may interchange the shape of the main body 10 with a geometric shape, such as rhomb, to make the present invention looks lightweight and aesthetic visually.

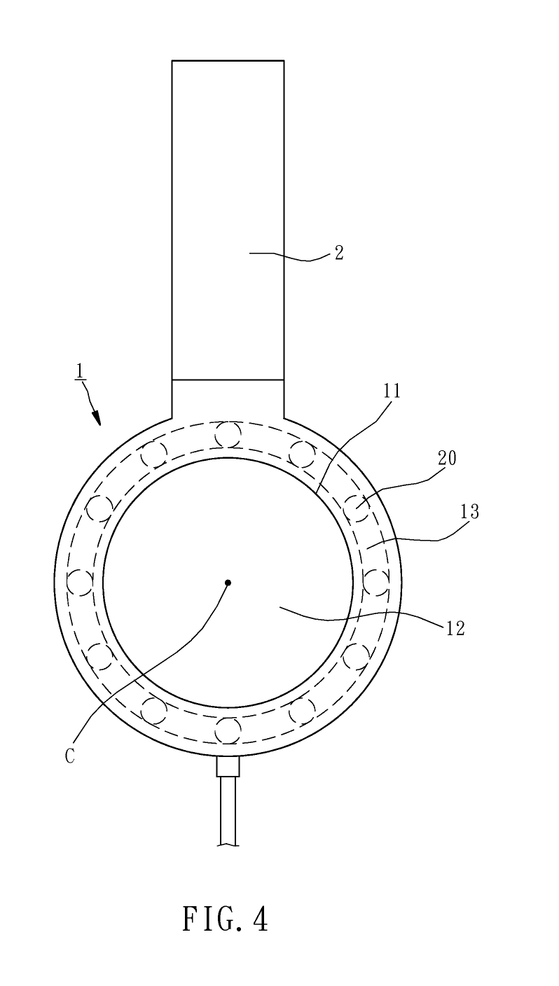

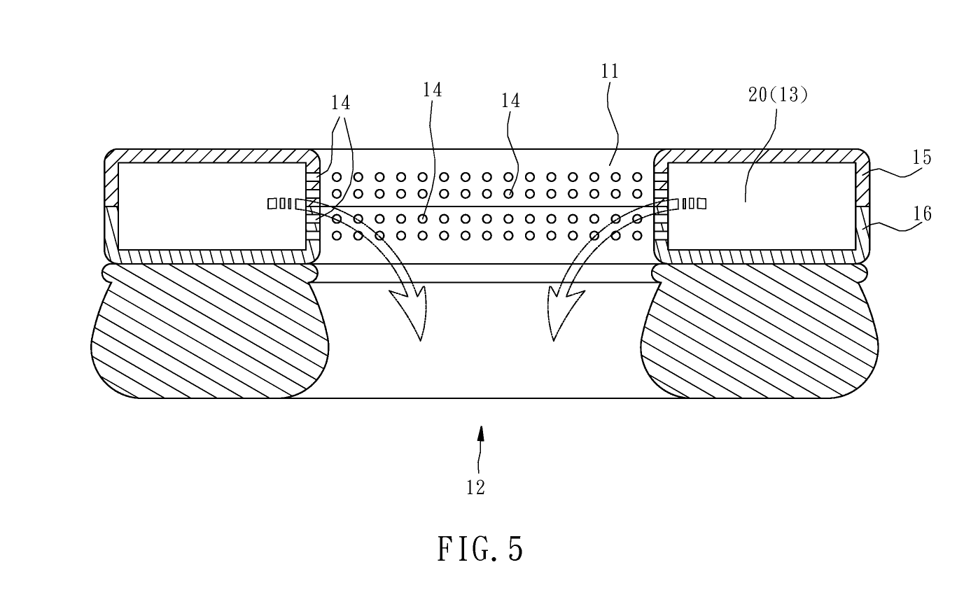

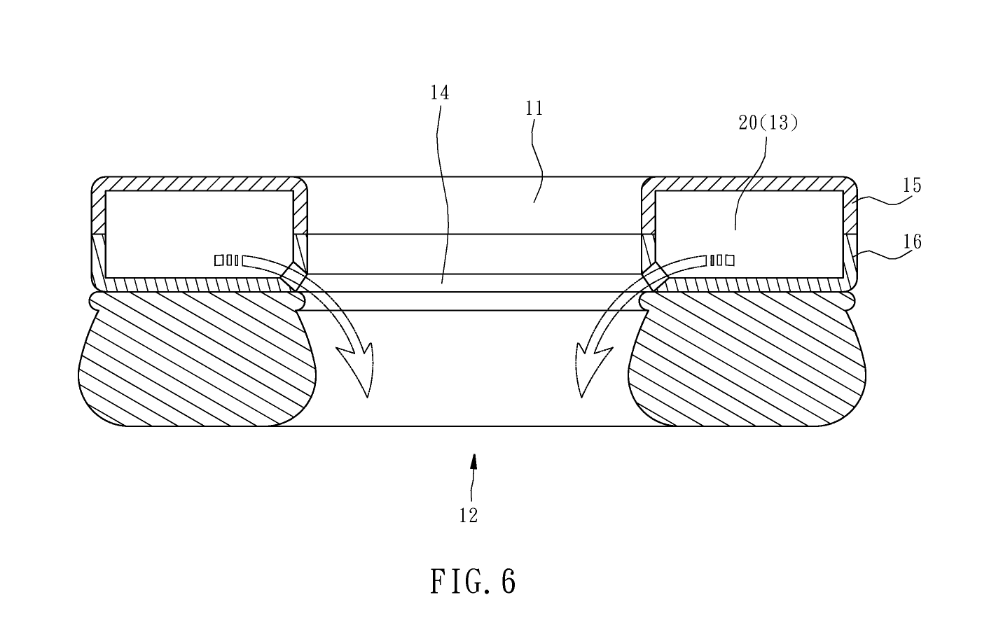

It is worth mentioning that the technician in this field can install the speaker of the audio unit 20 to the main body 10 to which the connector 2 is adjacent or interchange the audio unit 20 with multiple speakers arranged inside the accommodation space 13 in a predetermined interval, as shown in FIG. 4. In addition, the technician in this field can increase the number of the sound outlet 14 and make the multiple sound outlets 17 located on the first and second shells 15 and 16 and arranged along the lateral side 11 in a predetermined interval, as shown in FIG. 5. In an alternative pattern, the sound outlet 14 can be relocated to the second shell 16 to make the sound wave emitted by the audio unit 20 more centralized toward the user's ears, as shown in FIG. 6. In practice, the sound outlet 14 is interchangeable or variously formed as long as the sound outputted from the audio unit 20 can be successfully emitted from the sound outlet 14 to the audio cavity 12.

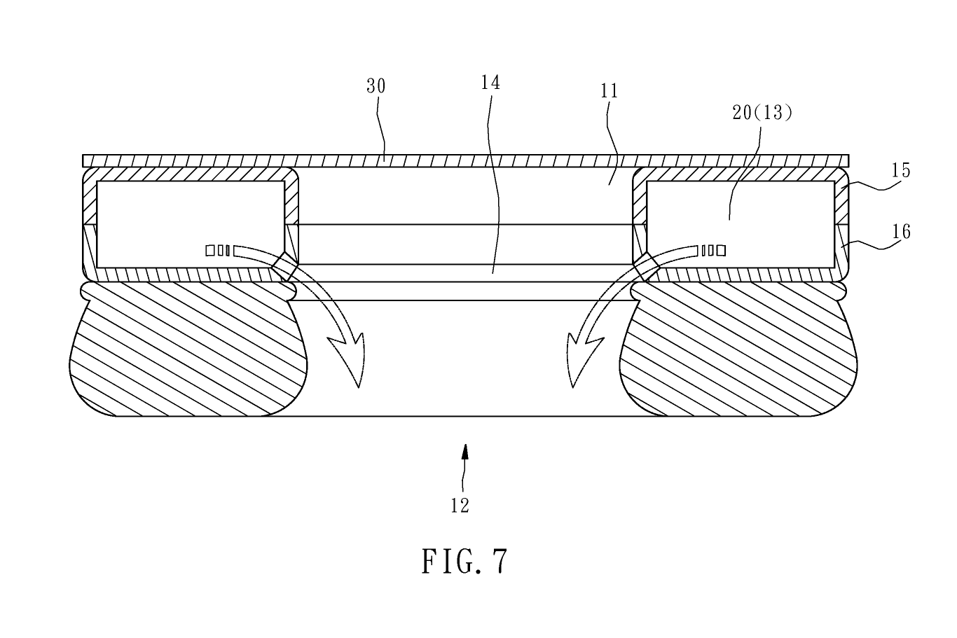

Referring to FIG. 7, to boost the bass of the sound outputted from the audio device 1 and to centralize and emit the sound to the user's ears, the sound outlet 14 is located on the second shell 16 and a transparent cover 30 is additionally mounted to an outer surface of the first shell 15 or deposited between the first and second shells 15 and 16 for sealing one side of the audio cavity 12 in this embodiment. Meanwhile, the audio cavity 12 is defined by the transparent cover 30 and the main body 10, or by the transparent cover 30 and the second shell 16. In this way, the sound wave emitted by the audio unit 20 will be centralized toward the user's ears and the sealed audio cavity 12 can provide preferable effect of the acoustic resonance In addition, the transparent cover 30 allows the light to penetrate therethrough to make the user's ears located inside the transparent cover 30 visible, so the audio device 1 of the present invention can also look hollow and lightweight visually.

What is claimed is:

1. An audio device for a headphone, comprising:
an annular main body and having a lateral side surrounding its center to define an audio cavity, the main body having an accommodation space internally, the lateral side having at least one sound outlet communicating with the accommodation space and the audio cavity; and
at least one audio unit mounted inside the accommodation space.

2. The audio device as defined in claim 1, wherein the audio unit including at least one speaker.

3. The audio device as defined in claim 2, wherein the speaker is plural in number and being arranged in an interval.

4. The audio device as defined in claim 2, wherein the speaker is annular in shape.

5. The audio device as defined in claim 1, wherein the accommodation space is annular in shape and the audio unit being arranged along the accommodation space of annular shape.

6. The audio device as defined in claim 1 being connected with a connector, wherein the accommodation space is located at the main body and adjacent to the connector.

7. The audio device as defined in claim 1, wherein the sound outlet is elongated and annular in shape.

8. The audio device as defined in claim 1, wherein the sound outlet is plural in number and the sound outlets are arranged along the lateral side in an interval.

9. The audio device as defined in claim 1 further comprising a transparent cover covering a side of the audio cavity.

10. An audio device for a headphone, comprising:
an annular main body and having a lateral side surrounding its center to define an audio cavity, the main body having an accommodation space internally, the lateral side having at least one sound outlet communicating with the accommodation space and the audio cavity; and
at least one audio unit mounted inside the accommodation space,
wherein the main body is formed of a first shell and a second shell butt in joint with the first shell.

11. The audio device as defined in claim 10, wherein the sound outlet is located at a gap between the first and second shells.

12. The audio device as defined in claim 10, wherein the sound outlet is located at the first shell or the second shell.

13. The audio device as defined in claim 12, wherein sound outlet is elongated and annular in shape.

14. The audio device as defined in claim 12, wherein the sound outlet is plural in number and the sound outlets are arranged along the lateral side in an interval.

15. The audio device as defined in claim 10 further comprising a transparent cover covering a side of the audio cavity.

16. The audio device as defined in claim 15, wherein the first shell is located in an outer side and the transparent cover mounted to an outer surface of the first shell, wherein the audio cavity is defined by the transparent cover and the main body.

17. The audio device as defined in claim 15, wherein the first shell is located in an outer side and the transparent cover deposited between the first and second shells, wherein the audio cavity is defined by the transparent cover and the second shell.
